(19) United States
(12) Patent Application Publication
(10) Pub. No.: US 2021/0172900 A1
(43) Pub. Date: Jun. 10, 2021

(54) METHOD FOR MONITORING THE VIABILITY OF A GRAFT

(71) Applicant: HEMARINA, Morlaix (FR)

(72) Inventor: Franck ZAL, Morlaix (FR)

(21) Appl. No.: 17/047,945

(22) PCT Filed: Apr. 15, 2019
(86) PCT No.: PCT/EP2019/059685

§ 371 Date: Oct. 15, 2020

(30) Foreign Application Priority Data
Apr. 17, 2018 (FR) 18 53340

(51) Int. Cl. G01N 27/409; A01N 1/02

(52) U.S. Cl. CPC G01N 27/409; G01N 2496/70; A01N 1/0273; A01N 1/0226

(57) ABSTRACT

The present invention relates to a method for monitoring the oxygenation of a graft, comprising:
a) mixing an organ storage solution preferably with at least one molecule chosen from extracellular hemoglobin from annelids, its globins and its globin protomers, in order to obtain a composition, in a sealed container;
b) immersion of the graft in the composition obtained in a);
c) the introduction of an oxygen probe in the composition obtained in a), or in the composition of step b); and
d) the closure of the hermetic container,
steps c) and d) being carried out simultaneously or in any order.

It also relates to a method for determining the viability of a graft.

The present invention relates to a method of monitoring the oxygenation of a graft while awaiting its transplantation.

The delivery of grafts requires particularly strict hygienic and temperature conditions in order to maintain the graft in a suitable state to be implanted. The conventional graft delivery procedure includes a first explanation step during which the graft is taken from a donor under aseptic conditions, generally in the operating room. The graft is then placed in a sealed jar which is placed in a first plastic bag hermetically sealed by a closure clip. This set is then placed in a second plastic bag of the same type and closed in the same way. The set is placed in an insulating transport cooler filled with a cooling substance (for example ice and/or eutectic gels) which makes it possible to maintain the graft at a temperature slightly above 0° C. The sachets covering the hermetic jar protect the graft from any contact with the cooling substance and with the ambient air potentially carrying germs. Upon arrival at the destination, the set consisting of the two sachets and the jar containing the graft is removed from the insulating transport cooler and introduced into the implantation room, which is also aseptic.

This method is therefore complicated: the packaging must be sterile, suitable for the organ, and transport must be carried out quickly.

Despite this, the transplant has a limited lifespan, which varies according to the organ (for example 4 hours for a heart, 10 hours for a liver and lungs 36 hours for a kidney).

There is, therefore, a need for a method making it possible to increase the viability of the graft, including during its transport. This method must be simple to implement, and must be compatible with all means of transport (road, but also air). This method should make it possible to physiologically assess the graft in a comprehensive and rapid manner.

The Applicant has now found a method that answers to this problem. This method is simple to implement, and makes it possible to prolong the life of the graft. In particular, the method according to the invention makes it possible to evaluate the oxygenation of the graft.

The object of the invention is therefore a method for monitoring the oxygenation of a graft, comprising:

a) providing an organ-storage solution in a sealed container. Preferably, the organ-storage solution is mixed with at least one oxygen carrier so as to obtain a composition. Preferably, the organ-storage solution is mixed with at least one oxygen carrier selected from extracellular hemoglobin of annelids, its globins and its globin protomers, in order to obtain a composition, in the sealed container,

b) immersing the graft in the solution or composition obtained in a), to obtain a second composition;

c) the introduction of an oxygen probe in the solution or the composition obtained in a), or in the second composition of step b); and

d) the closure of the hermetic container, steps c) and d) being carried out simultaneously or in any order.

The method according to the invention is thus concerned with a physiological parameter, i.e. the amount of dissolved oxygen present in the medium surrounding the graft. This thus accurately reflects the viability of the graft.

The method according to the invention may include a step e) of transporting the sealed container, in particular to the place of transplantation of the graft to a recipient.

The recipient is preferably a mammal. Preferably, the recipient is a human, in particular awaiting a transplant, or else a non-human mammal, for example a pig.

The method according to the invention comprises a step a) of providing an organ-storage solution in a sealed container. Such an organ-storage solution is, in particular, as described below.

Preferably, the organ-storage solution is mixed with at least one oxygen carrier. Preferably, the organ-storage solution comprises at least one oxygen carrier. Such an oxygen carrier is advantageously chosen from among molecules which bind oxygen in a reversible manner. Preferably such a carrier is chosen from among the extracellular hemoglobin of annelids, its globins and its globin protomers.

Preferably, the method according to the invention thus comprises a step a) of mixing an organ-storage solution with at least one oxygen carrier, preferably at least one molecule chosen from among extracellular hemoglobin from annelids, its globins and its globin protomers, in order to obtain a composition, in a sealed container.

The composition of step a) thus comprises:
at least one oxygen carrier, preferably at least one globin, a protomer of globin or an extracellular hemoglobin of annelids, and
an organ-storage solution.

The oxygen carrier according to the invention is preferably at least one molecule selected from among the extracellular hemoglobin of annelids, its globins and its globin protomers. The extracellular hemoglobin of annelids is present in all three classes of annelids: Polychaetes, Oligochaetes and Achetes. We speak of extracellular hemoglobin because it is naturally not contained in a cell, and may, therefore, circulate freely in the blood system without chemical modification to stabilize it or make it functional.

Annelid's extracellular hemoglobin is a giant biopolymer with a molecular weight between 2000 and 4000 kDa, made up of approximately 200 polypeptide chains ranging from 4 to 12 different types that are generally grouped into two categories.

The first category, comprising 144 to 192 elements, groups together the so-called “functional” polypeptide chains which carry an active site of the heme type, and are capable of reversibly binding oxygen; these are globin-type chains whose masses are between 15 and 18 kDa and which are very similar to the α and β-type chains of vertebrates.

The second category, comprising 36 to 42 elements, groups together the polypeptide chains called “structural” or “linkers” having little or no active site but allowing the assembly of subunits called twelfths or protomers.

Each hemoglobin molecule consists of two superimposed hexagons which have been called hexagonal bilayer, while each hexagon is itself formed by the assembly of six subunits (or “twelfths” or “protomers”) in the shape of a drop of water. The native molecule is made up of twelve of these subunits (dodecamer or protomer). Each subunit has a molecular mass between 200 and 250 kDa, and constitutes the functional unit of the native molecule.

Preferably, the extracellular hemoglobin of annelids is chosen from the extracellular hemoglobins of Polychete Annelids, preferably from the extracellular hemoglobins of the Arenicolidae family and the extracellular hemoglobins of the Neeididae family. Even more preferably, the extracellular hemoglobin of annelids is chosen from extracellular hemoglobin from Arenicola marina and extracellular hemoglobin from Nereis, more preferably extracellular hemoglobin from Arenicola marina.

According to the invention, the composition may also comprise at least one globin protomer of the extracellular hemoglobin of annelids. Said protomer constitutes the functional unit of native hemoglobin, as indicated above.

Finally, the composition may also include at least one globin chain from the extracellular hemoglobin of annelids. Such a globin chain may, in particular, be chosen from globin chains of the Ax and/or Bx type of extracellular hemoglobin from annelids.

Annelid extracellular hemoglobin and its globin protomers have intrinsic superoxide dismutase (SOD) activity, and therefore do not require any antioxidants to function, unlike the use of mammalian hemoglobin, for which the antioxidant molecules are contained inside the red blood cell and are not related to hemoglobin. On the other hand, the extracellular hemoglobin of annelids, its globin protomers and/or its globins do not require a cofactor to function, unlike mammalian hemoglobin, especially human. Finally, the extracellular hemoglobin of annelides, its globin protomers and/or its globins not having a blood type, they make it possible to avoid any problem of immunological reaction.

As demonstrated in the examples, the extracellular hemoglobin of annelides, in particular the extracellular hemoglobin of Arenicola marina, allows oxygen to be transferred to the graft for several hours, for example at least 10 hours, preferably at least 15 hours, preferably at least 20 hours, preferably at least 21, 22, 23, 25 or 28 hours, especially compared to the organ-storage solution alone.

In addition, the extracellular hemoglobin of annelides, in particular the extracellular hemoglobin of Arenicola marina, makes it possible to maintain the pO2 of the solution or composition in which the graft bathes at a constant level, for several hours, for example at least 10 hours, preferably at least 15 hours, preferably at least 20 hours, preferably at least 21, 22, 23, 25, 28 or 30 hours.

The organ-storage solution helps maintain the basic metabolism of the cells that make up the transplant. It meets a threefold objective: to wash the arterial blood of the graft, bring the graft uniformly to the desired storage temperature, and protect and prevent lesions caused by ischemia and reperfusion and optimize recovery of function. The organ-storage solution is therefore clinically acceptable.

The organ-storage solution is an aqueous solution having a pH between 6.5 and 7.5, comprising salts, preferably chloride, sulfate, sodium, calcium, magnesium and jarassium ions; sugars, preferably mannitol, raffinose, sucrose, glucose, fructose, lactobionate (which is a waterproofing agent), or gluconate; antioxidants, preferably glutathione; active agents, preferably xanthine oxidase inhibitors such as allopurinol, lactates, amino acids such as histidine, glutamic acid (or glutamate), tryptophan; and optionally colloids such as hydroxyethyl starch, polyethylene glycol or dextran.

According to a preferred embodiment of the invention, the organ-storage solution is chosen from among:
the University of Wisconsin solution (UW or Viaspan®), which has an osmolality of 320 mOsmol/kg and a pH of 7.4, of the following formulation for one liter, in water:
   Jarassium lactobionate: 100 mM
   KOH: 100 mM
   NaOH: 27 mM
   KH₂PO₄: 25 mM
   MgSO₄: 5 mM
   Raffinose: 30 mM
   Adenosine: 5 mM
   Glutathione: 3 mM
   Allopurinol: 1 mM
   Hydroxyethyl starch: 50 g/l,
IGL-1®, having an osmolality of 320 mOsm/kg and a pH of 7.4, with the following formulation, for one liter in water
   NaCl: 125 mM
   KH₂PO₄: 25 mM
   MgSO₄: 5 mM
   Raffinose: 30 mM
   Jarassium lactobionate: 100 mM
   Glutathione: 3 mM
   Allopurinol: 1 mM
   Adenosine: 5 mM
   Polyethylene glycol (molecular weight: 35 kDa): 1 g/l,
Celsior®, having an osmolality of 320 mOsm/kg and a pH of 7.3, with the following formulation for one liter in water
   Glutathione: 3 mM
   Mannitol: 60 mM
   Lactobionic acid: 80 mM
   Glutamic acid: 20 mM
   NaOH: 100 mM
   Calcium chloride dihydrate: 0.25 mM
   MgSO₄: 1.2 mM
   KCl: 15 mM
   Magnesium chloride hexahydrate: 13 mM
   Histidine: 30 mM,
SCOT 15 Multi Organs Abdominaux® and SCOT 30 Vascular Grafts® from Macopharma, both comprising, in particular, high molecular weight polyethylene glycol (20 kDa),
BMPS Belzer®, or Belzer machine perfusion solution, or KPS1, comprising, in particular, 100 mEq/l of sodium, 25 mEq/l of jarassium, a pH of 7.4 at room temperature, and having an osmolarity of 300 mOsm/A,
Custodiol® HTK Solution, of the following formulation for one liter in water, the pH being 7.20 at room temperature, and the osmolality being 310 mOsm/kg:
   NaCl: 18.0 mM
   KCl: 15.0 mM
   KH₂PO₄: 9 mM
   Hydrogenated jarassium 2-ketoglutarate: 1.0 mM
   Magnesium chloride hexahydrate: 4.0 mM
   Histidine, HCl,
   H₂O: 18.0 mM
   Histidine: 198.0 mM
   Tryptophan: 2.0 mM
   Mannitol: 30.0 mM
   Calcium chloride dihydrate: 0.015 mM,
Euro-Collins®, having an osmolality of 355 mOsm/kg and a pH of 7.0, and with the following formulation for one liter in water:
   Sodium: 10 mM
   Jarassium: 115 mM
   Chloride: 15 mM
   H₂PO₄⁻: 15 mM
   HPO₄²⁻: 42.5 mM
   HCO₃⁻: 10 mM
   Glucose: 194 mM,
Soltran®, having an osmolality of 486 mOsm/kg and a pH of 7.1, and of the following formulation for one liter in water:
   Sodium: 84 mM
   Jarassium: 80 mM
   Magnesium: 41 mM
   Sulphate-: 41 mM
   Mannitol: 33.8 g/l
   Citrate: 54 mM
   Glucose: 194 mM,
Perfadex®, with an osmolarity of 295 mOsmol/l and of the following formulation in water:
   50 g/l of dextran 40 (molecular weight: 40,000),
   Na+: 138 mM,
   K+: 6 mM,
   Mg2+: 0.8 mM,
   Cl−: 142 mM,
   O₄²⁻: 0.8 mM,
   (H₂PO₄⁻+HPO₄²⁻): 0.8 mM, and
   Glucose: 5 mM,
Ringer Lactate®, of the following formulation, in water, the pH being between 6.0 and 7.5 at room temperature, and having an osmolarity of 276.8 mOsmol/l:
   Na+: 130 mM,
   K+: 5.4 mM,
   Ca2+: 1.8 mM,
   Cl−: 111 mM,
   Lactates: 27.7 mM,
Plegisol®, of the following formulation, in water
   KCl: 1.193 g/l.
   MgCl₂.6H₂O: 3.253 g/l,
   NaCl: 6.43 g/l,
   CaCl₂: 0.176 g/l,
Solution from Hôpital Edouard Henriot, of the following formulation in water, the pH being equal to 7.4 at room temperature, and having an osmolarity of 320 mOsmol/l:
   KOH: 25 mM,
   NaOH: 125 mM,
   KH₂PO₄: 25 mM,
   M MgCl₂: 5 mM,
   MgSO₄: 5 mM,
   Raffinose: 30 mM,
   Lactobionate: 100 mM,
   Glutathione: 3 mM,
   Allopurinol: 1 mM,
   Adenosine: 5 mM,
   Hydroxyethyl starch 50 g/l,
and the Steen® solution, comprising human serum albumin, dextran and extracellular electrolytes with a low concentration of jarassium.

All of these organ-storage solutions are commercial products.

Preferably, the composition of step a) has a pH of between 6.5 and 7.6, and comprises:
at least one globin, one globin protomer or one extracellular hemoglobin from annelids, preferably Arenicolidae,
calcium ions, preferably in an amount between 0 and 0.5 mM;
KOH, preferably in an amount between 20 and 100 mM;
NaOH, preferably in an amount between 20 and 125 mM;
KH2PO4, preferably in an amount between 20 and 25 mM;
MgCl2, preferably in an amount between 3 and 5 mM;
at least one sugar chosen from among raffinose and glucose, preferably in an amount between 5 and 200 mM;
adenosine, preferably in an amount between 3 and 5 mM;
glutathione, preferably in an amount between 2 and 4 mM;
allopurinol, preferably in an amount between 0 and 1 mM; and
at least one compound chosen from hydroxyethyl starch, polyethylene glycols of different molecular weights and human serum albumin, preferably in an amount between 1 and 50 g/l.

Typically, the extracellular hemoglobin of annelides, its globin protomers and/or its globins, is present at a concentration, relative to the final volume of the composition, of between 0.001 mg/ml and 100 mg/ml, preferably between 0.005 mg/ml and 20 mg/ml, more preferably between 0.5 mg/ml and 5 mg/ml, in particular 1 mg/ml.

Typically, the composition of step a) has an osmolarity of between 250 and 350 mOsm/l, preferably between 275 and 310 mOsm/l, more preferably of about 302 mOsm/l.

The sealed container used in the method according to the invention, in particular in step a), is any container suitable for transporting the graft. Such containers are known from the prior art. In particular, the container may be as described in application FR2994163. Preferably, the sealed container may correspond to the Biotainer 2.8l kit. It may be included in a carrying case, such as that marketed under the name Vitalpack® EVO™ by E3 Cortex.

Preferably, the sealed container is a jar (or rigid primary packaging)—of sufficient size to contain the graft and the composition from step a)—closed with a lid with a handle. Preferably, the lid comprises an opening, preferably circular, allowing the passage of the oxygen probe. This opening is waterproof: the edges of the opening are preferably coated with a waterproof seal and allow the oxygen probe to be attached.

Preferably, the sealed container is placed in a flexible plastic container as defined below, defining a first hermetic interior volume called useful volume and a second hermetic volume called reserve volume adjacent to the first volume, a sealing element extending between the two volumes to define a hermetic border between the two volumes. In particular, the sealed container is placed in the useful volume. Finally, the sealed container, placed in the useful volume of the container, may be placed in a transport bag. A refrigerant substance, especially used during transport, may be placed in the container.

Preferably, the flexible plastic container defines a first sealed interior volume (useful volume) and a second sealed volume (reserve volume) adjacent to the first volume, a sealing element extending between the two volumes to define a hermetic boundary between the two volumes. The first volume comprises at its end opposite to the second volume a device for opening and hermetically sealing a first access to the first volume, the second volume being shaped so that a cutout through the second volume releases two grippable portions of the container, the separation of which removes the hermetic border between the two volumes to form a second access to the first volume distinct from the first access. Thus, the cutout of the reserve volume protects the sealing element from any retention of liquid, in particular of the refrigerant substance used during transport. In particular, any traces of liquid remain on the outer wall of the container, while the interior of the gripping portions (and therefore the sealing element) are preserved from any pollution. The separation of the gripping portions ensures that no pollution can migrate towards the sealing element.

The introduction of the sealed container through a first access and its extraction through a second access protects the sealed container, by preventing the latter from being exposed to possible contamination of the first access which would have taken place during packaging operations.

Advantageously, such a container is produced by superimposing two sheets of flexible plastic material having free edges joined together. In this way, the container may be easily made to the dimensions of the content (sealed container). The joined edges of the plastic sheets may be joined together using peelable bonds. This then allows, by simple traction, a corollary opening of the sachet over its entire length and releases the content without it being necessary to roll up the packaging around the sealed container.

Advantageously, the sealing element comprises a peelable connection between two plastic surfaces.

At the end of step a), an organ-storage solution is thus obtained and contained in a sealed container.

At the end of step a), a composition is preferably obtained, based on hemoglobin, globin, or annelid globin protomer and an organ-storage solution, contained in a sealed container.

Step b) then comprises immersing the graft in this composition. The graft may be any organ that may be transplanted. Preferably, the graft is a kidney, a heart, a pancreas, a lung, a liver or else a heart-lung unit.

At the end of step b), a graft is then obtained which is immersed in the solution obtained in step a) or in the composition obtained in step a). Preferably, the graft is completely immersed in the solution or the composition.

Thus, the amount of solution or composition used varies according to the volume of the graft. For example, the composition (milliliter):graft (gram) weight ratio is between 2:1 and 4:1.

Then, the method according to the invention comprises the introduction of an oxygen sensor in the solution or composition obtained in a), or in the composition of step b): this is step c).

It is important to note that the oxygen probe is introduced directly into the composition, and not on the graft. In fact, the classic monitoring of graft oxygenation typically includes the evaluation of the rate of oxygen consumption of the total organ (WOOCR for whole organ oxygen consumption rate), and uses an oxygen probe which is placed directly on the graft irrigation systems, for example on the artery and vein (therefore upstream and downstream) of the graft. Such a manipulation is not necessarily easy to implement, takes some time (at least a few minutes), and may be harmful to the graft.

On the contrary, according to the method of the present invention, the oxygen probe is directly introduced into the composition or the solution in which the graft is bathed. This avoids any invasive step in the graft.

Thus, step c) of the method according to the invention preferably comprises the introduction of a single oxygen probe in the solution or composition obtained in a), or in the composition of step b). The oxygen probe is preferably single. In particular, the method according to the invention does not use two oxygen probes.

The oxygen probe introduced is, in particular, not placed in contact with the graft, in particular not directly on a graft irrigation system (i.e. artery or vein). Preferably, the oxygen probe is introduced into the organ storage solution comprising at least one oxygen carrier, in which the graft bathes.

The oxygen probe, or oximeter, used makes it possible to measure the concentration of molecular oxygen in the liquid mixture obtained in a) or b), therefore to measure the quantity of dissolved oxygen present in the solution or composition of step a) or in the composition of step b). This measure avoids any invasive step in the graft.

Preferably, the oxygen probe is a Clark electrode. It comprises a probe head coated with a membrane, the probe head consisting of an electrode composed of a platinum cathode and a silver anode immersed in an electrolyte (in particular an alkaline solution of sodium phosphate Na₃PO₄, for example at 50 g/l). The electrode/electrolyte assembly is separated from the liquid medium by the membrane, which is permeable to dioxygen but impermeable to water and ions.

The operating principle is as follows: a potential difference (for example 800 mV) is established between anode and cathode, the oxygen present between the electrodes is reduced. The resulting intensity of the current is proportional to the oxygen concentration in the electrolyte.

Preferably, according to another embodiment, the oxygen probe is a sensor for measuring dissolved oxygen by optical measurement, in particular by luminescence. In this case, it does not include a membrane or an electrolyte. Such a probe is commercially available, in particular under the reference Optod (Digisens range) by Ponsel.

Preferably, the oxygen probe is a portable model, preferably a pocket model. Preferably this is the ProfiLine Oxi 3205 model from WTW.

Preferably, the probe is waterproof. Preferably, it is attached to the lid of the sealed container.

According to the present invention, in step c), the oxygen probe is placed directly in the composition, therefore in the medium in which the graft is immersed. It is much simpler and more convenient, and faster. In addition, this step is not harmful to the graft, because it is strictly non-invasive.

According to one embodiment, the oxygen probe may be introduced directly into the solution or composition obtained in step a), then the graft is added to said composition.

According to another embodiment, the graft is first added to the solution or composition of step a), then the oxygen probe is introduced into the resulting mixture. In fact, since the probe is, in particular, fixed on the lid of the sealed container, it may be introduced into the mixture at the same time as the step of fixing the lid on the sealed container, therefore at the same time as step d).

The method according to the invention comprises a step d) of closing the sealed container. According to the invention, steps c) and d) may be performed simultaneously, or in any order.

As indicated above, in the case where the probe is attached to the lid of the sealed container, it may be introduced into the mixture at the same time as the step of fixing the lid on the sealed container; in this case, steps c) and d) are simultaneous.

If the probe is not yet attached to the lid, it may be inserted:
either before the container is closed: in this case, step c) takes place before step d);
or after closing the container in this case, step d) takes place before step c).

Once the container is closed, the graft may thus be transported under good conditions to its destination.

In particular, thanks to the presence of the oxygen probe in the composition, monitoring of the oxygenation of the graft is carried out in real time.

Furthermore, by the presence of a globin, a protomer of globin or an extracellular hemoglobin of annelids in the composition, the transport may be effected by any means (ground or air transport), and not require any special condition. This is therefore advantageous compared to the use of gaseous oxygen, which is present in specific containers (bottles in general) maintained at a given pressure, and therefore less easy to transport (especially by air).

Transport step e) may be carried out by placing the sealed container in a suitable container. Such a container is known from the prior art, and is suitable for transporting grafts. Preferably, this container is a transport bag, for example as described in application EP1688124. It is more particularly a case for transporting a graft for transplantation comprising at least one internal wall delimiting at least two compartments each having an openable part, a first compartment being intended to receive one or more vials and/or jars of biological samples from the donor (for example, blood) protected by a block of flexible and elastic material, while a second compartment contains an isothermal tank intended to receive the sealed container according to the invention. The isothermal tank may include crushed ice or blocks of eutectic material.

In particular, transport is carried out by placing the sealed container in a case marketed under the name Vitalpack® EVO™ by E3 Cortex.

According to the present invention, the graft may be stored in dynamic perfusion.

The method according to the invention may also comprise, after step d) and/or e), a step e) of establishing a calibration curve representing the pO2 of the composition obtained in a) in which the graft is immersed, optionally normalized with respect to the weight of the graft, as a function of time.

The pO2 is especially expressed in mmHg or in bar or in %.

Obtaining this calibration curve makes it possible to deduce, for a given graft, the optimal duration of oxygenation. For example, for a kidney, obtaining a calibration curve allows the maximum duration of oxygenation to be deduced, if a pO2 of at least 50% is desired.

Thus, the present invention also relates to a method of determining the viability of a graft, comprising the use of the calibration curve described above. This curve is, in particular, obtained according to the method described above.

Such a method for determining the viability of a graft includes the following steps, in particular:

(i) providing an organ-storage solution in a sealed container. Preferably step (i) comprises mixing an organ-storage solution with at least one oxygen carrier chosen from extracellular hemoglobin from annelids, its globins and its globin protomers, in order to obtain a composition, in a sealed container,
(ii) immersing the graft in the solution or the composition obtained in (i);
(iii) the introduction of an oxygen probe in the solution or the composition obtained in (i), or in the composition of step (ii);
(iv) closing the sealed container, with steps (ii) and (iv) being carried out simultaneously or in any order, then
(v) transport of the sealed container, in particular to the place of transplantation of the graft to a recipient,

and wherein the maximum time elapsing between step (ii) and the end of step (v) is determined according to the calibration curve described above, keeping said pO2 at a physiologically acceptable value.

By “physiologically acceptable pO2 value” is meant a value which gives the viability of the graft.

It should be noted that all the operating conditions and embodiments of steps (i) to (v) are as described for steps a) to e) above.

The invention is now illustrated with the aid of the following examples.

### EXAMPLE 1: STORAGE STUDY OF A PIA KIDNEY IN A PRESERVATIVE SOLUTION WITH OR WITHOUT ANNELID HEMOGLOBIN

The aim of this study is to establish a link between the effects of extracellular hemoglobin from Arenicola marina (M101) on the reduction of ischemia/reperfusion lesions in static cold storage and the mechanism of action of the molecule. In order to establish this link, sequential measurements are performed at both the functional level and the cellular level.

Methods

1. HEMO2life®

Arenicola marina extracellular hemoglobin was used to formulate a commercial product, HEMO2life® (Hemarina SA), an additive to storage solutions. HEMO2life® is manufactured in accordance with EU Good Manufacturing Practice for Medicines.

2. Storage of the Kidney

Both kidneys were explanted from the same animal (pig) 18 minutes after the circulatory arrest.

The kidneys were washed with 200 ml of UW (Bridge to Life) organ-storage solution or 200 ml of UW+1 g/l HEMO2life®. The kidneys were weighed after tightening. The kidneys were immediately immersed in a tightly closed organ reservoir and filled with 800 ml of their respective solutions (standard solution: UW and UW+HEMO2life® 1 g/l) at 6° C.

Then the reservoirs were transported to the laboratory under hypothermic conditions at 4° C. while successive measurements for pO2 and biomarkers start at 1 hour.

Two other reservoirs (controls) are used to measure the same parameters with no kidney inside, and serve as controls for both UW and UW+HEMO2life® g/l.

The reservoirs were placed on a shaking table with slow shaking.

3. Analyzes

Functional Analyzes of M101

The sequential measurement was carried out at 1 h, 4 h, 6 h, 24 h, 30 h, 48 h, 55 h: HEMO2life® functional analyzes.

Binding to oxygen: the functionality of M101 is followed by spectrophotometry allowing the characterization of oxyhemoglobin (HbO₂) and deoxyhemoglobin (deoxy-Hb). The absorption spectra are recorded over the 370-640 nm range (UVmc2, SAFAS, Monaco) according to the method described by Thuiller et al. 2011, Supplementation With a New Therapeutic Oxygen Carrier Reduces Chronic Fibrosis and Organ Dysfunction in Kidney Static Storage: A New O2 Therapeutic Molecule Improves Static Kidney Storage. Am J Transplant. 2011 September; 11 (9): 1845-80.

pO2 and pH Monitoring

Sequential measurements were taken every hour from 1 h to 12 h; 24 h to 36 h and 48 to 55 h for the pH and dissolved O2 of the storage solution.

Dissolved O2 (dO2) and pH are measured using an O2 sensor (WTW Oxi 3205) and a pH sensor (WTW pH3110) directly in the closed (hermetic) tank.

Results

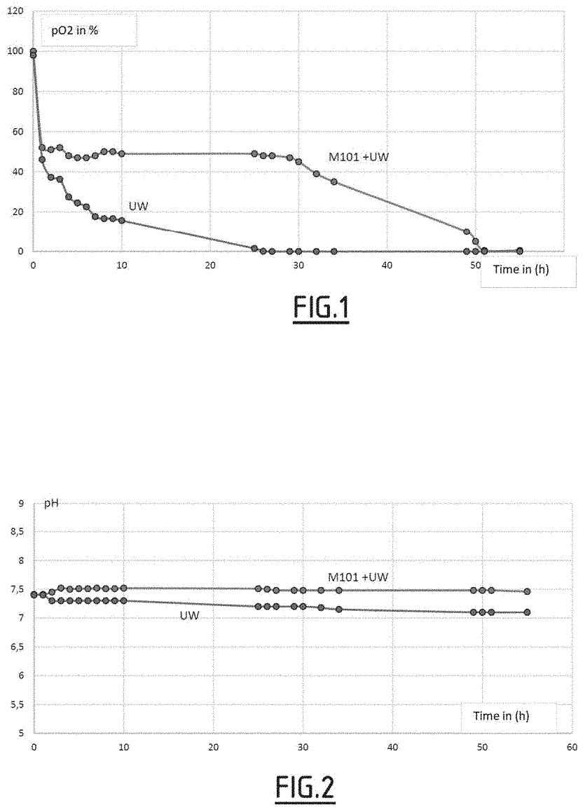

The results are in FIGS. 1 and 2.

Functional Analyzes of M101

The functional analyzes show that the spectral signature of M101 from t0 to 52 h reveals the presence of hemoglobin in the oxyHb form. The molecule remains in the oxyHb form from the start until 52 h, which means that there is oxygen available in the storage solution.

The spectral signature of M101 from 52 h to 55 h is characteristic of deoxyHb and shows that the molecule has transferred all of its oxygen to the solution.

pO2 and pH Monitoring

For the controls, the pO2 was measured at 100% dissolved O2 in the two reservoirs at t0 and does not decrease for 55 hours at 6° C.

This means that there is no O2 uptake in these kidney-free conditions.

For the kidneys, their respective weight is 273.4 g (UW+HEMO2life® 1 g/l) and 268.0 g (UW). The room temperature during the experiment is kept at 6° C.

The pO2 is indexed to 100% dissolved O2 at 6° C. at the start of the experiment. The first hour, the pO2 decreases rapidly to 50% in both solutions.

The results on pO2 are in FIG. 1. The pO2 continues to decrease sharply in the solution which does not contain HEMO2life® to reach 0% after 24 h. The evolution of pO2 in the storage solution containing HEMO2life® is slowed down and then stabilized for 1 to 30 hours at approximately 50% dissolved oxygen (p50). This plateau therefore corresponds to the situation in which pO2=p50. It is only after 30 h that the dissolved oxygen slowly drops back to 0% at 52 h.

These results, coupled with the functional results, show that HEMO2life® is a good carrier of oxygen and is able to distribute it as it is stored, from t0 up to 52 hours. At 52 h, parallel pO2 measurements and functional analysis show that at this time, dissolved O2 is at 0% in the storage solution, which means that HEMO2life® has delivered all of its transported oxygen. HEMO2life® is a very good donor of oxygen to a fluid. The molecule distributes oxygen to maintain 50% of dissolved O2 from 1 h to 30 h, then until the oxygen transported is exhausted from 30 to 52 h. A decline is observable at 30 h and the dissolved O2 slowly decreases to reach 0% at 52 h. Without HEMO2life®, 50% of the pO2 is reached after 1 h, and the pO2 already reaches 0% after 24 h.

The results on pH are in FIG. 2. In the reservoir not containing kidney, the pH was measured. It is very stable in the two reservoirs containing UW (pH of 7.4), and UW+HEMO2life® 1 g/l (pH of 7.5).

In reservoirs with kidneys, the pH is very stable in the solution to which HEMO2life® 1 g/l has been added, around 7.4, from the start up to 55 h. The pH in UW storage solution without HEMO2life® 1 g/L decreases from 7.4 to 7.1 in 55 h. The difference is probably explained by the acidosis of the reservoir containing the kidney without HEMO2life® 1 g/l.

These results clearly demonstrate the beneficial use of HEMO2life® at 1 g/L in addition to the low temperature storage solution. The evolution of pO2 shows that HEMO2life® transfers oxygen 28 h more than the storage solution alone. In addition, HEMO2life® maintains dissolved oxygen in the 50% solution for 30 h, i.e. at a constant level allowing much better storage of the organ. Biochemical analyzes confirm these results.

1. Method of monitoring the oxygenation of a graft, comprising:
a) providing an organ storage solution and mixing the organ storage solution with at least one oxygen carrier, to obtain a composition, in a sealed container,
b) immersing the graft in the composition obtained in step a) to obtain a second composition;
c) introducing an oxygen probe in the composition obtained in a), and/or in the second composition of step b); and
d) hermetically closing the sealed container, steps c) and d) being carried out simultaneously or in any order.

2. Method according to claim 1, wherein:
the at least one oxygen carrier is an extracellular hemoglobin a globin from annelids or a globin protomer from annelids.

3. Method according to claim 1, further comprising a step e) of transporting the sealed container to the place of transplantation of the graft to a recipient.

4. Method according to claim 1, wherein step c) comprises introducing a single oxygen probe in the composition obtained in a), or in the second composition obtained in step b).

5. Method according to claim 1, wherein the oxygen probe of step c) is a Clark electrode or sensor for measuring dissolved oxygen by optical measurement.

6. Method according to claim 1, wherein the oxygen probe of step c) comprises a probe head coated with a membrane, the probe head consisting of an electrode composed of a cathode of platinum and with a silver anode immersed in an electrolyte, said membrane being permeable to oxygen but impermeable to water and to ions.

7. Method according to claim 1, comprising a step e′) of establishing a calibration curve representing the pO2 of the composition obtained in a) in which the graft is immersed, optionally normalized relative to the weight of the graft, as a function of time.

8. (canceled)

9. Method of determining the viability of a graft comprising:
(i) providing an organ-storage solution with at least one oxygen carrier, in order to obtain a composition, in a sealed container;
(ii) immersing the graft in the composition obtained in (i) to obtain a second composition;
(iii) introducing an oxygen probe in the composition obtained in (i), and/or in the second composition of step (ii);
(iv) closing the sealed container, steps (iii) and (iv) being carried out simultaneously or in any order; then
(v) transporting the sealed container, to the place of transplantation of the graft to a recipient,
vi) during steps ii) to v), monitoring the dissolved oxygen in the second composition, wherein the amount of dissolved oxygen indicates the viability of the graft.

10. Method according to claim 2, wherein the extracellular hemoglobin of annelids is an extracellular hemoglobin of a Polychete Annelid.

11. Method according to claim 1, wherein the organ-storage solution is an aqueous solution having a pH between 6.5 and 7.5, comprising salts; sugars; antioxidants; active agents; and, optionally, colloids.

12. The method of claim 5, wherein the optical measurement is luminescence.

13. The method of claim 9, wherein the at least one oxygen carrier is an extracellular hemoglobin of annelids, a globin of annelids or a globin protomer of annelids.

14. The method of claim 10, wherein the Polychete Annelid is of the Arenicolidae family or the Nereididae family.

15. The method of claim 14, wherein the Arenicolidae family is Arenicola marina.

16. The method of claim 9, further comprising a step of establishing a calibration curve representing the pO2 of a composition obtained in which the graft is immersed, optionally normalized relative to the weight of the graft, as a function of time.

17. The method of claim 11, wherein:
the salts include chloride, sulfate, sodium, calcium, magnesium and jarassium;
the sugars include mannitol, raffinose, sucrose, glucose, fructose, lactobionate and gluconate;
the antioxidants include glutathione;
the active agents include xanthine oxidase inhibitors and amino acids; and,
the colloids include hydroxyethyl starch, polyethylene glycol or dextran.

18. The method of claim 17, wherein
the xanthine oxidase inhibitors include allopurinol and lactates; and
the amino acids include histidine, glutamic acid and tryptophan.
